(19) United States
(12) Patent Application Publication
(10) Pub. No.: US 2003/0000119 A1
(43) Pub. Date: Jan. 2, 2003

(54) Identifying tag

(76) Inventor: Philippe Savy, Monterol (CH)

Correspondence Address: McGlew & Tuttle, Scarborough Station, Scarborough, NY, 10510-0827, US

(21) Appl. No.: 10/182,357

(22) PCT Filed: Jan. 11, 2001
(86) PCT No.: PCT/IB01/00019

(30) Foreign Application Priority Data
Feb. 2, 2000 (EP) 00101997.5

(51) Int. Cl. G09F 3/00

(52) U.S. Cl. 40/301

(57) ABSTRACT

The invention concerns an identification tag consisting of a first (10) and a second plate (12) one of which (12) is provided with a rod (24) having a perforating and retaining head (32), defining a first axis, to form a male element and the other (10) comprises an orifice (26) for receiving and maintaining the head (32) of the rod (24) and constituting a female element. The invention is characterized in that the plates (12) are linked to each other articulated about a second axis, with a hinge (14) formed by: at least a knuckle (16), secured to the first plate (10), a pivot (18) coaxial with and engaged in the knuckle (16) and an elastic member arranged so as to be deformed when a force exceeding a threshold value is applied, thereby enabling the pivot (18) to be released from the knuckle (16).

### FIELD OF THE INVENTION

The present invention relates to identification tags, for example of the type intended to be fixed to the ears of bovine animals in order to be able to identify the animal. Such tags are well known to those skilled in the art.

### BACKGROUND OF THE INVENTION

One of these tags is disclosed in Swiss Patent No. 595 060. It includes two plates of flexible material, and a pin connecting the two plates. More precisely, the pin, which is secured to and arranged perpendicularly to one of the plates, forms therewith a male element. The pin is provided with a shoulder at its free end. It is pierced along its entire length by an-axial bore in which a nail provided with a point, is engaged when the plates are assembled.

The other plate includes a reinforced circular opening, intended to receive the end of the pin, and whose diameter is greater than the diameter of the pin but less than the diameter of the shoulder. It thus forms a female element.

The tag is secured to an animal's ear, by means of a known type of pliers-type applicator. The pliers position the two plates such that the nail pierces the ear, then the shoulder of the tag engages in the opening of the female element. After the operation, the pin is removed. The shoulder thus locks the male and female elements axially, the latter being able to rotate in relation to each other.

Since the plates are made of a flexible material, they deform resiliently when they encounter an obstacle, so that the animal carrying a tag of this type does not risk hurting itself by becoming caught.

This tag has, however, two major drawbacks. Since the male and female elements are not connected to each other prior to being secured to the ear, only one of them must carry data or they must be matched to guarantee the coherence of the set.

Moreover, assembly has to occur by means of a tool, which complicates implementation and may lead to problems, if hygiene measures are not respected.

The identification tag disclosed in French Patent No. 2 442 583 allows these drawbacks to be overcome. It includes a male part forming a pin with a piercing and retaining head, and a female part provided with an opening intended to receive the pin head. These two parts are made in a single piece, by injection moulding plastic material. They are connected to each other in a resilient manner, by a bridge of less thick material. Consequently, when the two parts are assembled, the piece bends at the bridge.

This tag can be secured without using any particular tool. However, it has the drawback that, if the animal is caught on the loop which the tag forms when installed, it is likely to hurt itself, or tear off part of its ear and lose its mark. It is, moreover, difficult to guarantee precise bending. The pin may then not be properly engaged in the opening, which prolongs the tag installation time and causes discomfort for the animal with the reactions that this may involve.

The main object of the present invention is to propose a tag allowing the advantages of the two tags described hereinbefore to be combined, while avoiding their drawbacks.

### SUMMARY OF THE INVENTION

The tag according to the invention is formed of a first and second plate, one of which is provided with a pin with a piercing and retaining head, which form, together, a male element and the other one of which includes an opening intended to receive and hold the pin head and forms a female element. It is characterised in that the plates are connected to each other by means of a hinge, formed of:

at least a knuckle, secured to the first plate,

a pivot secured to the second plate, coaxial with and engaged in the knuckle, and

a resilient member, which is deformed when a force exceeding a threshold value is applied, thereby enabling the pivot to be released from the knuckle.

Such a tag structure allows assembly without any tools, owing to the fact that the male and female elements are perfectly positioned in relation to each other, because of the hinge which connects them. Moreover, the risk of mixing up two plates to be assembled is also removed. Further, since the two elements separate at the hinge, in the event of the tag becoming caught, the risk of the animal being hurt and/or the tag being lost is considerably reduced.

Advantageously, the knuckle includes a housing in which the cylindrical pivot is engaged. It is provided with a longitudinal slot, which defines two lips surrounding the pivot and forming the resilient member. Consequently, articulation occurs in good conditions, while properly controlling the separation of the knuckle and the pivot.

Experience has shown that, unlike most applications, it is not necessary to have a very resistant pivot and that the most favourable solution consists in making it with the same material and at the same time as the second plate. Such a solution thus allows the safety of the device to be increased while reducing the cost thereof.

In order to assure proper positioning of the plates in relation to each other, and thus to facilitate engagement of the pin in the opening of the female element, the hinge includes two knuckles and two pivots each engaged in one of the knuckles.

The tag according to the invention is installed without having to use any tools. In order to ensure optimum working conditions, it is desirable to be able to hold the tag with a single hand, the plates remaining separated, despite the pressure exerted to hold the tag. This is made possible owing to the fact that one of the plates is provided with a resilient tongue arranged in proximity to the hinge. This tongue extends in the direction of the other plate to co-operate with its inner wall. It is arranged so as to:

hold the plates resiliently in an open position, in which the pin is distant from the opening, to facilitate installation of the tag,

bend when being installed, and

match the surface of the wall after being installed.

In order to guarantee maximum safety when worn and proper rigidity of the tag assembly, the plates are made of a flexible plastic material, whereas the pin, made of hard plastic material, is provided, at one of its ends, with a dish-shaped head moulded in the flexible plastic material of the plate of the male element, and at the other of its ends, with a retaining shoulder and a hole arranged along the axis of the pin. A metal nail, abutting against the shoulder, is engaged in the hole. Its head has a shape allowing perforation of a live organ. The female element plate opening is partially closed by snugs extending radially towards its centre, the distance between the snugs being greater than the diameter of the pin, but less than the dimension of the shoulder, in its part intended to co-operate with the snugs.

In order to facilitate installation, and more particularly engaging the pin in the opening, the snugs define a guide cone, open towards the male element plate, arranged for facilitating engagement of the pin in the opening.

In order to protect the shoulder from any risk of disengaging from the female element plate, the opening is surrounded by a tubular wall arranged on the outer face of the female element plate, defining a housing arranged for receiving the nail and the shoulder.

It has been observed that particularly advantageous results are obtained when the shoulder is formed of wings extending radially from the pin outwards, and that the snugs extend radially from the wall of the opening towards its centre, the wings and the snugs including support surfaces respectively parallel to the inner faces of the plates of the male and female elements.

### DESCRIPTION OF THE DRAWINGS

Other advantages and features of the invention will appear from the following description, made with reference to the annexed drawing, in which:

FIG. 1 shows, in perspective, a tag according to the invention;

FIGS. 2 and 3 are longitudinal cross-sections of the tag of FIG. 1, in the open and closed positions; and

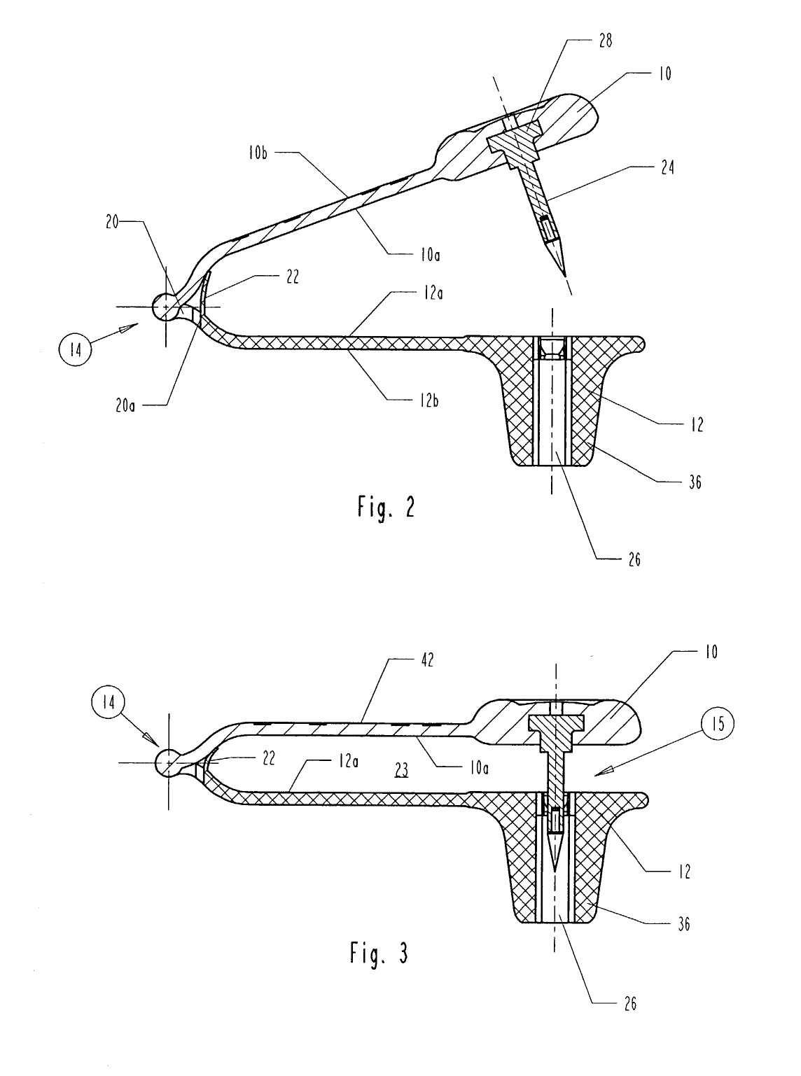

FIGS. 4 and 5 show respectively, in lateral cross-section, the assembling means and the hinge.

### DESCRIPTION OF THE PREFERRED EMBODIMENT

The identification tag shown in the drawing is formed of two plates 10 and 12, a hinge 14, and assembling means 15.

Plates 10 and 12 are made of injected plastic material, for example flexible PVC. They include inner faces 10a and 12a and external faces 10b and 12b. Prior to being fixed, they are connected to each other, in an articulated manner, by a hinge 14.

Hinge 14 includes two knuckles 16 and two pivots 18, respectively integral with plates 12 and 10.

Each knuckle 16 is defined by a portion of tube provided with a longitudinal slot 16a, open on the side of inner face 12a, and the width of which is less than the diameter of pivots 18. The tube, thus provided with a slot, forms a resilient member capable of being deformed radially. Typically, the diameter of pivots 18 is equal to 1.5 mm and the width of the slots is 1.1 mm. With a tube wall of approximately 1 mm, one obtains resilience such that it is possible easily to assemble and dismantle the two parts 10 and 12 of the tag, without thereby involving any risk of disengaging when it is being installed.

Knuckles 16 define, between them, a cut out portion 20 for receiving the end of plate 10 carrying pivots 18. Cut out portion 20 includes a wall 20a which extends from one of the knuckles to the other and extends, in the direction of plate 10, via a tongue 22 having a thickness of 0.3 to 0.4 mm and a length of approximately 6 mm. This tongue 22 acts as a support for plate 10, so that the person who has to secure the tag can hold it with light pressure on external faces 10b and 12b of plates 10 and 12 without the tag closing.

In proximity to hinge 14, the two plates have a slight S-shaped curve, such that in the closed position, inner faces 10a and 12a are parallel and distant from each other and form a space 22 for receiving the member on which the tag has to be secured, for example the ear of a bovine. This space is advantageously comprised between 5 and 10 mm.

Thus, before the tag is installed and because of the hinge, the two plates are secured to each other, free in rotation, but kept separated by tongue 22.

Assembling means 15 are formed of a pin 24, secured to plate 10 and which forms, with the latter, a male element, and of an opening 26 made in plate 12, which thus defines a female element.

Pin 24 is advantageously made of a hard plastic material, for example polyamide, assembled to plate 10 by overmoulding. The end of pin 24, which is in plate 10, is provided with a dish 28 assuring the solidity of the assembly.

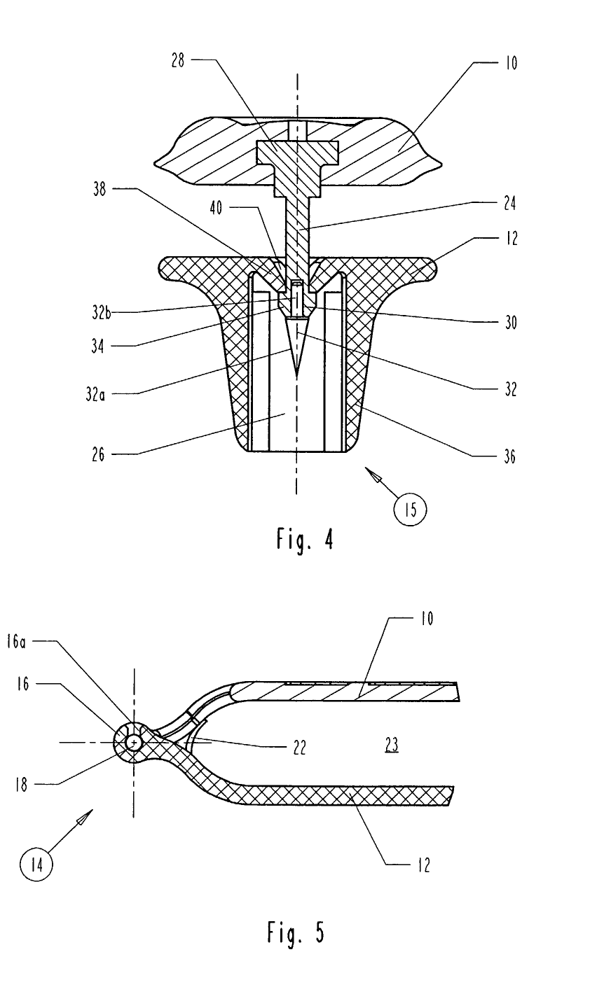

As can be seen more precisely in FIG. 4, the free end of pin 24 is pierced with an axial hole 30 into which a stainless steel nail 32 is driven, including a conical external part 32a and a cylindrical part 32b engaged in the hole. This end is also provided with two diametrically opposite wings 34, extending radially outwards and which extend conical part 32a.

Plate 12 includes a tubular wall 36 which extends perpendicularly from the external face 12b and which forms a housing proportioned so as to be able to receive the end of pin 24 and more particularly, nail 32 and wings 34. This housing is partially closed on the side of inner wall 12b by two snugs 38 which extend radially towards the centre and axially towards the interior of the housing.

The ends of snugs 38 define a passage of generally cylindrical shape, the diameter of which is substantially equal to that of pin 24, extended towards inner face 12b by a guide cone 40 whose base has a diameter approximately two times greater than the distance separating wings 34, so as to be able to guide pin 24 easily when it is being engaged.

Snugs 38 also define, in the housing, a plane support surface, parallel to inner face 12a, for co-operating with wings 34 after the engagement thereof in plate 12, to prevent them from coming out again. Moreover, traction on the pin tends to bend snugs 38, which brings them into contact with the cylindrical part of the pin and locks it all securely.

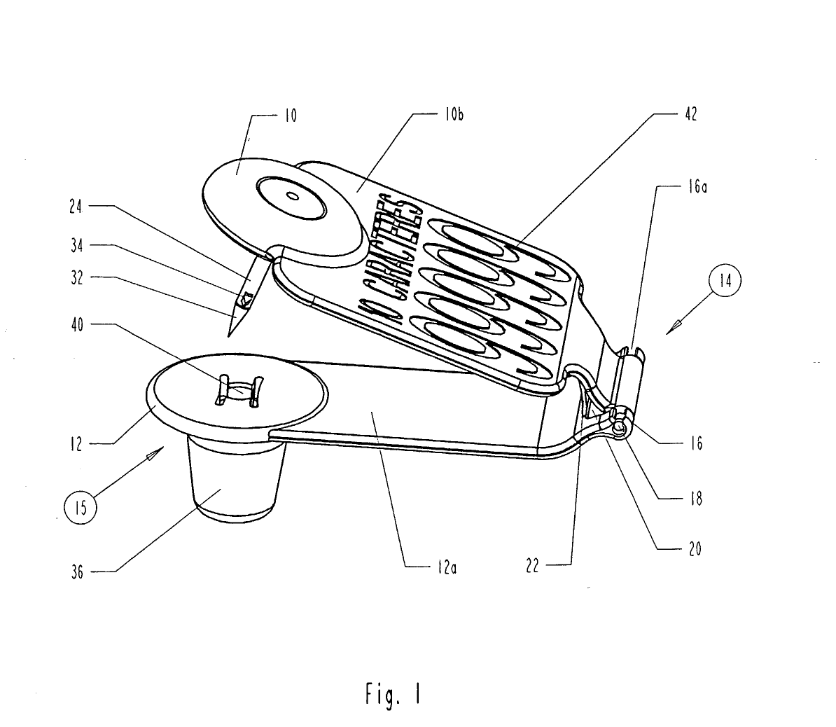

As can be seen in FIG. 1, plate 10 is intended to receive, in its median part, inscriptions 42 identifying the animal wearing the tag. Plate 12 can also bear identifying inscriptions. The latter are not, however, visible in the drawing. These inscriptions can be made by any means, for example during moulding, by laser engraving, or by means of heat embossing.

Installation of the tag according to the invention is easy and secure. After having taken the necessary hygiene measures, one need only grasp the tag holding it by external faces 10b and 12b. Because of the resilient strip, it is possible to hold the two plates 10 and 12 firmly, without thereby reducing the distance between the end of the nail and inner face 12a. The tag is then slipped on either side of the ear of an animal to be identified, onto which it has to be secured, after which the pressure on external faces 10b and 12b is increased. Nail 32 then pierces the ear then engages in guide cone 40, which thus causes pin 24 to penetrate between snugs 38. The latter are separated, which allows wings 34 to pass, which engage behind them, thus locking pin 24, secured to plate 10, in plate 12. The two plates are, consequently, fixed to each other in a secure and inseparable manner.

It should be noted that stainless steel nail 32, is only in contact with the animal's body during perforation of the ear. Immediately after that moment, only the polyamide of pin 24 is in direct contact with the animal's body. This material is well tolerated by the organism, unlike stainless steel, which may sometimes be allergenic, because it releases nickel.

If, during its life, the animal becomes caught, not only must it not be hurt, but also it must not lose the identification tag. In order to assure this double function, hinge 14 is arranged such that pivots 18 come out of knuckles 16 when a force tending to separate them is applied thereto. Tests carried out have shown that a threshold value of the order of 1 to 5 daN assures installation in good conditions while ensuring disengagement without any risk of injury.

After disengagement, plates 10 and 12 are only secured to each other by pin 24. This securing is however, amply sufficient to hold the tag in place for several years.

Such a solution thus allows the advantages of the solutions described in the aforementioned documents to be combined, while avoiding the drawbacks.

The tag described may form the subject of various variants without thereby departing from the scope of the invention. Both the shapes and the materials used can be changed. The manufacture of hinge 14 in particular may include numerous variants. Thus it is possible to make a hinge with a single pivot and one knuckle. It is also possible to replace the cylindrical pivots by conical or spherical pivots. In such case, the resilient member will be deformed axially rather than radially.

Pin 24 can also be made in various ways. It is thus possible to make it entirely of metal, for example, stainless steel. In such case, care will be taken to ensure that the material used does not pose problems as regards the animals' health.

The example described hereinbefore is, more particularly, intended for large cattle and especially cows. The same principle may, of course, be applied to tags of smaller dimensions, intended to be secured to the ears of goats or rabbits. One need only reduce the dimensions accordingly.

The way in which data appears could also be subject to numerous variants, for example by using a bar code or an electronic system.

The main application relates to breeding cattle. It is clear that other fields could also be envisaged, for example for marking live or dead game, or inert objects taking the form of sheets that can be perforated.

What is claimed is:

1. An identification tag formed of a first and a second plate, one of which is provided with a pin with a piercing and retaining head, defining a first axis, to form a male element and the other of which includes an opening for receiving and holding the head of the pin and forming a female element, wherein the plates are connected to each other in a hinged manner around a second axis, by means of a hinge, formed of:
at least a knuckle, secured to the first plate;
a pivot coaxial with and engaged in the knuckle, and
a resilient member arranged so as to be deformed when a force exceeding a threshold value is applied, thereby allowing said pivot to be released from the knuckle.

2. A tag according to claim 1, wherein the pivot is cylindrical and the knuckle includes a housing in which the pivot is engaged, and wherein the knuckle includes a slot parallel to the second axis and which defines two lips that surround the pivot and form the resilient member.

3. A tag according to claims 1 or 2, wherein said pivot is integral with said second plate.

4. A tag according to any of claims 1 to 3, wherein the hinge includes two knuckles and two pivots each engaged in one of the knuckles.

5. A tag according to any of claims 1 to 4, wherein one of said plates is provided with a resilient tongue arranged in proximity to the hinge and extending in the direction of the other plate so as to co-operate with its inner wall, and arranged so as to:
hold the plates resiliently in an open position, in which the pin is distant from the opening, to facilitate installation of the tag,
bend when being installed, and
match the surface of said wall after being installed.

6. A tag according to any of claims 1 to 5, wherein the plate of the male element is made of a flexible plastic material and wherein the pin is made of hard plastic material provided at one of its ends with a dish moulded in the flexible plastic of the plate of the male element, and at its other end with a retaining shoulder and an opening arranged axially and in which is held a metal nail whose head, which has a shape allowing perforation of an organ, abuts against the shoulder, and wherein the opening of the plate of the female element is partly closed by snugs extending radially towards its centre, the distance between the snugs being greater than the diameter of the pin, but less than the dimension of said shoulder in its part intended to co-operate with the snugs.

7. A tag according to claim 6, wherein said snugs define a guide cone, open towards the plate of the male element, arranged to facilitate engagement of the pin in the opening.

8. A tag according to claim 6 or 7, wherein said opening is surrounded by a tubular wall arranged on the outer face of the plate of the female element, defining a housing arranged for receiving the nail and the shoulder.

9. A tag according to any of claims 6 to 8, wherein said shoulder is defined by wings extending radially from said pin towards the exterior and wherein said snugs extend radially from the wall of the opening towards the first axis, the wings and the snugs including support surfaces respectively parallel to the inner faces of the plates of the male and female elements.
